(19) United States
(12) Patent Application Publication
(10) Pub. No.: US 2007/0197325 A1
(43) Pub. Date: Aug. 23, 2007

(54) Traction Mechanism Drive, In Particular A Belt Drive

(75) Inventors: Ralph Painta, Hagenbuchach (DE); Michael Bogner, Eckental (DE); Herbert Graf, Bischberg (DE)

Correspondence Address: VOLPE AND KOENIG, P.C., UNITED PLAZA, SUITE 1600, 30 SOUTH 17TH STREET, PHILADELPHIA, PA, 19103, US

(73) Assignee: SCHAEFFLER KG, Herzogenaurach, DE (DE)

(21) Appl. No.: 10/598,806

(22) PCT Filed: Feb. 11, 2005
(86) PCT No.: PCT/EP05/01374

§ 371 Date: Oct. 3, 2006

(30) Foreign Application Priority Data
Mar. 12, 2004 (DE) 10 2004 012 141.9

(51) Int. Cl. F16H 7/14; F16H 7/12

(52) U.S. Cl. 474/117; 474/133

(57) ABSTRACT

A traction mechanism drive, in particular a belt drive, is provided having an integrated generator with a traction mechanism roller which is dosposed on the generator shaft, whereon the traction mechanism is guided and which is mounted in a displaceable manner in order to apply tension to the traction mechanism against a returning force. The traction mechanism roller (4) can be decoupled from the generator shaft (12) via a freewheel (11) in order to dampen peak loading exerted on the operational side.

### BACKGROUND

The invention relates to a traction mechanism drive, in particular a belt drive, comprising an integrated generator with a traction mechanism roller, which is arranged on a generator shaft, on which the traction mechanism is guided, and which is mounted in a displaceable manner in order to set the traction mechanism in tension counter to a returning force.

In traction mechanism drives, especially in belt drives, in order to be able to safely transfer the necessary drive moments to the secondary assemblies, a sufficient pretensioning force must be guaranteed in the traction mechanism. Simultaneously, the number and arrangement of secondary assemblies must be kept as low or compact as possible, in order to be able to avoid, as much as possible, unnecessary disturbance variables (e.g., additional fluctuating deflections of the traction mechanism due to idler or traction pulleys) in the drive. If a disadvantageous drive layout, e.g., a two-pulley drive with fluctuating deflection, is added to the output of the secondary assemblies, which are becoming increasingly more and more powerful, after one or more tensioning devices, then a sufficient service life with conventional tensioning devices cannot be realized. Due to the short length of the belt and the resulting frequency of the fluctuating deflection loading, the belts age prematurely. If it were possible to reduce the number of fluctuating deflections and in the ideal case to even completely eliminate them, then an increase in the belt service life would be possible without a problem. To reduce the number of local fluctuating deflection points, it is possible to draw on the generator itself integrated in the drive as a tensioning device for the traction mechanism. That is, in this respect a double function is added to the generator, first its original generator function, and second, that of a tensioning device. In this way, one or even more tensioning devices, which would otherwise also be integrated in the drive and which would lead to fluctuating deflection points, are eliminated. Unfortunately, due to the large mass, which the generator has and which must be moved for tensioning, compensation of dynamic effects, that is, dynamic changing loads on the drive, is possible only to a limited extent or to almost no extent. Thus, if changing peak loads occur frequently in the drive, for guaranteeing the peak-load damping, a corresponding damping ability, usually the required integration of a tensioning device, is to be selected, which, however, is disadvantageous in its end effect for the reasons named above.

### SUMMARY

Therefore, the invention is based on the objective of providing a traction mechanism drive, especially a belt drive, which, in contrast to the foregoing, is improved.

To meet this objective, in a traction mechanism drive of the type noted above, it is provided according to the invention that the traction mechanism roller can be decoupled from the generator shaft via a freewheel in order to dampen peak loads occurring on the drive side.

The freewheel provided on the generator side according to the invention allows the traction mechanism roller to be decoupled temporarily with special advantage in order to dampen peak loads, so that despite the inertia of the generator tensioning system, it does not have a disadvantageous effect in the drive. That is, possible rotational non-uniformities of the crankshaft or the like, which lead to dynamic peak loads, can be damped by the decoupling of the generator proposed according to the invention, which leads to quiet running of the belt drive. The peak loads are at least partially relieved; the influence on the belt and also on the bearings of the integrated secondary assemblies can be reduced.

The generator itself can be configured as a simple generator, which is used merely for generating current, when, e.g., the internal combustion engine, to which the traction mechanism drive is allocated, is in operation. Alternatively, it can also involve a starter generator, which also has a starter function, by means of which the drive can be actively driven temporarily until the associated internal combustion engine is running and the belt drive itself begins to drive, then the starter generator behaves as a pure generator. In this case, a double freewheel with a start-stop function is preferably to be provided, which allows the traction mechanism roller to lock with the generator shaft during the startup phase, that is, when the starter generator is used as a starter motor, wherein this locking in the generator mode must be forcibly released and the second freewheel function can be engaged, if necessary, namely when impermissibly high peaks loads occur, so that the traction mechanism roller coupled up until now is decoupled from the shaft. The generator, especially the starter generator itself can preferably be moved by means of a hydraulic element, in principle it is mounted so that it can pivot about a pivot axis, wherein the restoring force required for tensioning is generated via the hydraulic element. Alternatively, a mechanical spring element exerting a tensile or compressive force can be used, with integrated or external damping.

### BRIEF DESCRIPTION OF THE DRAWINGS

FIG. 1 shows a basic representation of a traction mechanism drive, especially a belt drive,

FIG. 2 shows an end view of the starter generator shown in the drive from FIG. 1,

FIG. 3 shows a view, partially in section, of the starter generator from FIG. 2 in a position turned by 90°,

FIG. 4 shows a diagram for representing the effect of the generator freewheel provided according to the invention as a function of the driving rotational speed, and

FIG. 5 shows a diagram for representing the peak-load damping over time for the use of the generator freewheel according to the invention.

### DETAILED DESCRIPTION OF THE PREFERRED EMBODIMENTS

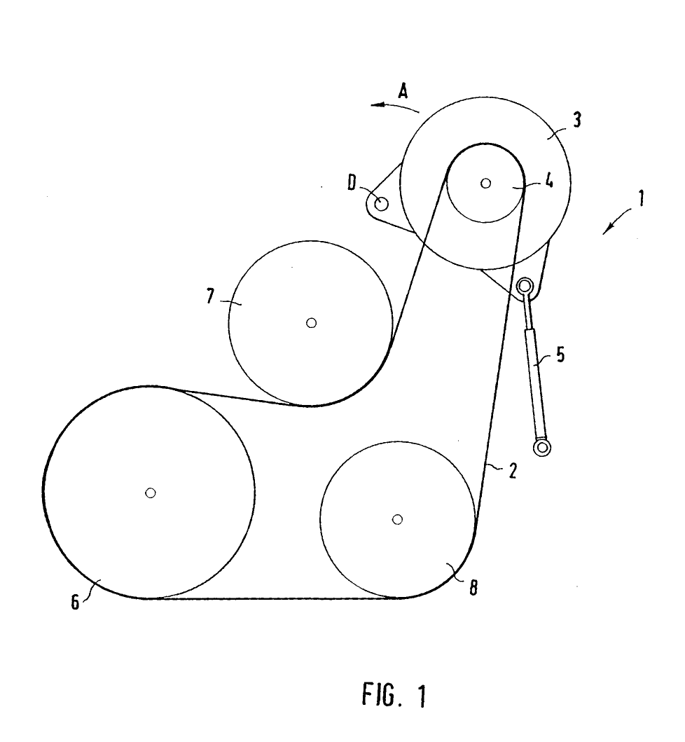

FIG. 1 shows a traction mechanism drive 1 according to the invention, here a belt drive, with a belt 2 that is guided via several assemblies. Integrated in the belt drive is, for one, a generator 3, e.g., a starter generator, on which a belt roller 4 is arranged on a generator shaft, through which the belt 2 is guided. The generator 3 is mounted so that it can pivot about a point of rotation D. A tensioning mechanism 5, which engages the generator and which is shown only as an example in the form of a hydraulic tensioning element, which exerts a continuous restoring force on the generator, which forces this generator in the direction of the arrow A around the point of rotation D, and which thus tightens the belt 2.

Furthermore, in the illustrated example, integrated into the traction mechanism drive 1 is a crankshaft 6, which is actively driven in the startup case via the starter generator 3, that is, in this case the starter generator 3 itself drives the traction mechanism drive 1, and which, on its side, actively drives the traction mechanism drive when the associated internal combustion engine, not shown here in more detail, is running.

Furthermore, in the illustrated example a water pump 7 and also an air-conditioner compressor 8, which are operated via the drive 2, are integrated, naturally with corresponding pulleys being provided to the corresponding assemblies, over which the belt 2 runs. FIG. 1 is merely a basic representation that shows an arbitrary belt drive, which, however, naturally can also be designed completely differently and integrated into the other assemblies.

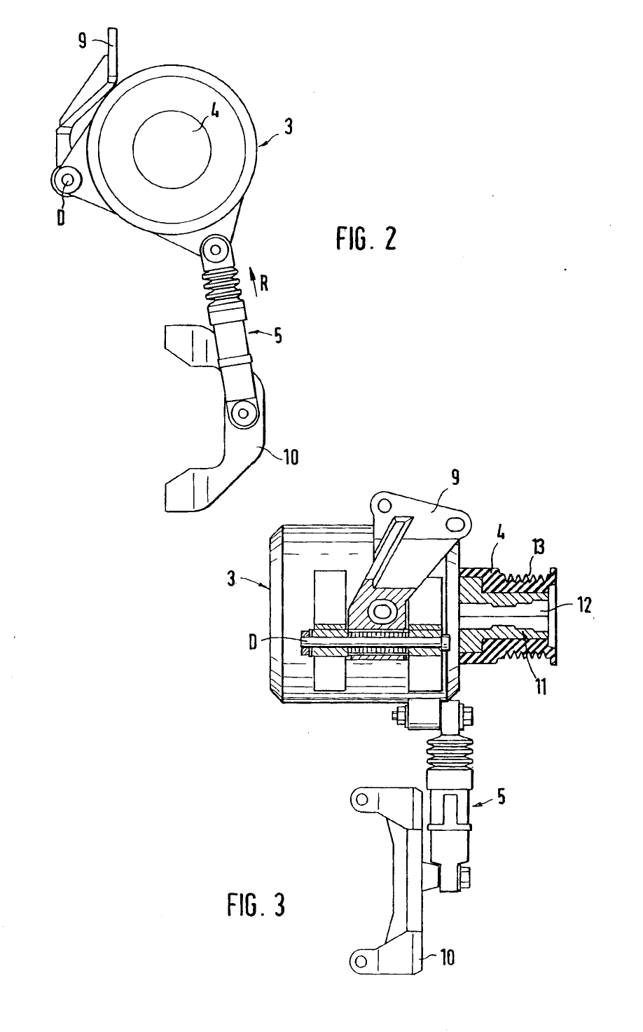

As described, the starter generator 3 is mounted so that it can pivot and counteract a restoring force. FIGS. 2 and 3 show different views of one possible embodiment of the starter generator. On the generator housing, an attachment part 9, a so-called bracket, is provided, by which the generator 3 is mounted, for example, on the engine of the motor vehicle or the like. This arrangement provides a possibility for a pivoting support of the generator 3, so that this can be pivoted about the point of rotation D.

Further shown is the hydraulic element 5, which is mounted by a suitable support 10, for example, also directly on the engine block or on some other tertiary object. The hydraulic element 5 generates a continuously acting restoring force, which acts in the direction of the arrow R on the generator 3 and tensions the generator.

Through this pivoting support, for the possibility of simultaneous tensioning of the starter generator 3, the traction mechanism drive 1 can be tensioned continuously and independently in each mode (that is, during startup or generator mode). Due to the inertia of the generator 3, which, as a rule, weights between 3-6 kg (in comparison to other tensioning devices that are used, which weigh between 300-1000 g and thus are significantly more agile) it is only conditionally possible to be able to sufficiently dampen and relieve dynamic peak loads of high frequency.

For this purpose, the traction mechanism roller 4 can be decoupled from the generator shaft 12 through a freewheel 11. That is, the traction mechanism roller 4, thus here the belt roller, which shows a corresponding rib profile 13, in which a corresponding V-belt is guided, decouples when a peak load appears, thus rotates freely relative to the generator shaft 12, so that the peak loads that appear do not exert a force completely onto the traction mechanism drive. Such peak loads could result, for example, due to rotational non-uniformities of the crankshaft 6.

Because the generator 3 involves a starter generator, the freewheel 11 is constructed as a double-function freewheel with a start-stop function. This double-function freewheel allows, first, the traction mechanism roller 4 to be forcibly coupled to the generator shaft 12 in the startup phase, that is, when a compulsory coupling is required, in order to transfer moments to be applied to the traction mechanism drive when the starter generator 3 is operated as a starter motor, in order to actuate the associated internal combustion engine. When the internal combustion engine is running, the temporary startup coupling is released and the traction mechanism roller 4 is coupled as before with the generator shaft 12, in order to drive the generator in the generator mode. Through the second freewheel, this coupling is then decoupled when peak loads appear, with the non-positive connection between the intermediate roller 4 and the generator shaft 12 being released temporarily and the freewheel disengaged.

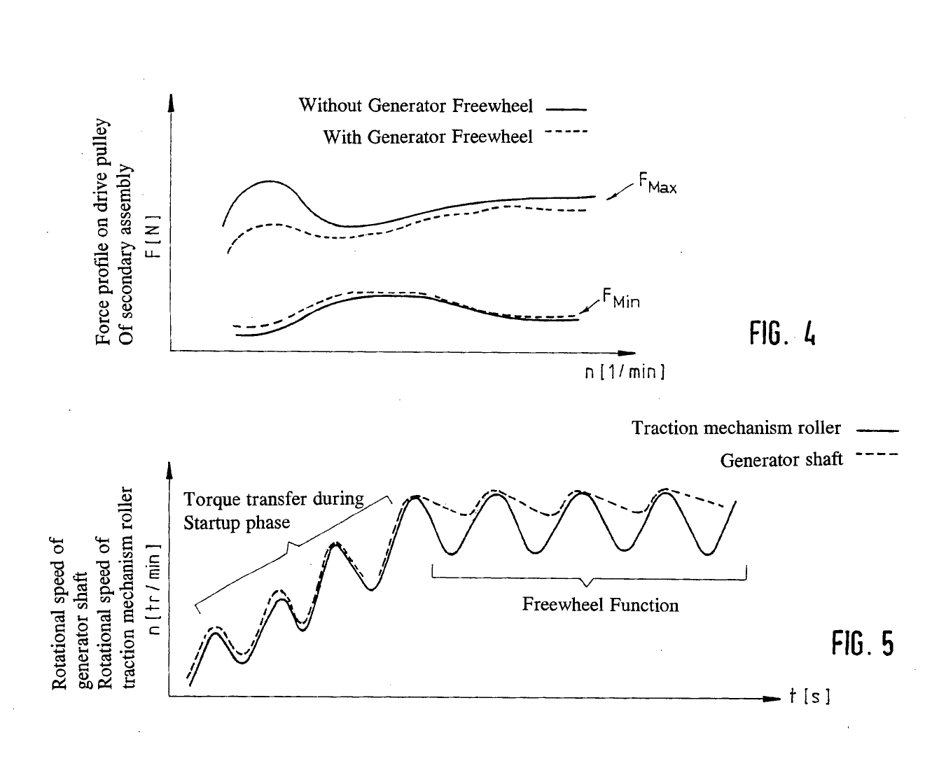

The effectiveness of the use of a generator freewheel is shown with reference to FIGS. 4 and 5. As a schematic diagram, FIG. 4 shows the force profile, recorded along the ordinate, on a drive pulley of a secondary assembly in the traction mechanism drive from FIG. 1, here, for example, the water pump, which is connected between the crankshaft and the generator. Along the abscissa, the rotational speed of the drive is recorded. The two curves that are shown are the envelope curves of the maximum and minimum belt force on the drive pulley during operation. A considerable range of variation is produced due to irregularities, with this being pronounced especially in the range of low rotational speeds. The solid line represents the force profile without a generator freewheel and the dotted line represents the force profile with a generator freewheel. Obviously, the marked maximum can be significantly reduced in the range of lower rotational speeds if the maximum force has a decreasing trend.

The relatively high maximum force applied to the secondary assembly drive pulley results from the rotational inertia of the generator about the point of rotation D or also from its rotor mass. If the traction mechanism drive is driven via the crankshaft when the engine is running, the water-pump drive pulley is located on the loose side of a belt, followed by the rotating generator. Due to the fluctuations in the crankshaft rotational speed, the belt drive is accelerated and braked as a function of the fluctuation. When accelerating, the generator is also accelerated, which has no effect on the loose side of a belt. However, when slowing down, the generator is abruptly braked, which leads to a resulting tensile force on the water-pump drive pulley on the loose side of the belt in front of the generator. From this, the relatively high maximum force results.

Now, in the case if the generator is decoupled through the use of the freewheel according to the invention, then the generator shaft is not actively braked, its rotational speed decreases only due to its own friction, etc., the generator shaft rotates loosely relative to the roller, and the force applied to the water-pump drive pulley dependent on fluctuation is inevitably significantly lower than FIG. 4 shows.

In the form of a schematic diagram, FIG. 5 shows the rotational speed of the generator shaft, recorded along the ordinate, in the form of the dashed line, as well as the rotational speed of the generator-side traction mechanism roller in the form of the solid line. It is apparent that the two lines overlap congruently in the startup phase, when, due to the start-stop coupling of the starter generator, the roller and the shaft are locked in rotation with each other. When the engine is running and the traction mechanism drive is driven by the crankshaft, the temporary decoupling is performed as a function of applied peak loads, so that the shaft and roller rotate freely relative to each other. The roller follows the strong rotational speed variation of the crankshaft, transmitted directly by the belt. This is shown in the very wavy solid line. The generator shaft rotating freely after the decoupling is not braked at this moment, thus its rotational speed decreases only slightly, and rises again, dependent on the renewed coupling, only when the belt rotational speed rises again, dependent on an increase in the crankshaft rotational speed.

### REFERENCE SYMBOLS

1 Traction mechanism drive
2 Belt
3 Generator
4 Belt roller
5 Tensioning mechanism
6 Crankshaft
7 Water pump
8 Air-conditioning compressor
9 Attachment part
10 Support
11 Freewheel
12 Generator shaft
13 Rib profile
A Arrow
D Point of rotation
R Arrow

1. Traction mechanism drive comprising an integrated generator with a traction mechanism roller, which is arranged on a generator shaft, on which a traction mechanism is guided, the generator is mounted in a displaceable manner in order to set the traction mechanism in tension counter to a restoring force, the traction mechanism roller is de-couplable from a generator shaft of the generator via a freewheel for damping peak loads appearing on a drive side.

2. Traction mechanism drive according to claim 1, wherein the generator is a starter generator.

3. Traction mechanism drive according to claim 1, wherein the generator is mounted in a displaceable manner by a hydraulic element.

4. Traction mechanism drive according to claim 1, wherein the generator is set in tension or compression by a mechanical spring element.

5. Traction mechanism according to claim 4, further comprising a damping device that acts in conjunction with the spring element.

6. Traction mechanism drive according to claim 1, wherein the tractor mechanism is a belt.
